(19) United States
(12) Patent Application Publication
(10) Pub. No.: US 2006/0235151 A1
(43) Pub. Date: Oct. 19, 2006

(54) High-temperature endurable phase-change polymer

(75) Inventor: Yen-Hsi Lin, Taipei City (TW)

Correspondence Address: MARSHALL, GERSTEIN & BORUN LLP, 233 S. WACKER DRIVE, SUITE 6300, SEARS TOWER, CHICAGO, IL, 60606, US

(73) Assignee: TAIWAN TEXTILE RESEARCH INSTITUTE, Tu-Chen City (TW)

(21) Appl. No.: 11/392,394

(22) Filed: Mar. 29, 2006

(30) Foreign Application Priority Data
Apr. 14, 2005 (TW) 94111871

(51) Int. Cl. C08L 63/00

(52) U.S. Cl. 525/107

(57) ABSTRACT

A high-temperature endurable phase-change polymer has a polyether main chain and two fatty acyl terminals. The polyether main chain is polyethylene glycol or polytetramethylene glycol. The two fatty acyl terminals are preferably stearoyl group, palmitoyl group, or lauroyl group.

### RELATED APPLICATIONS

The present application is based on, and claims priority from, Taiwan Application Serial Number 94111871, filed Apr. 14, 2005, the disclosure of which is hereby incorporated by reference herein in its entirety.

### FIELD OF THE INVENTION

This invention relates to phase-change polymers, and more particularly to high-temperature endurable phase-change polymers.

### BACKGROUND OF THE INVENTION

Phase-change materials (PCMs) undergo physical phase changes, e.g. solid phase to liquid phase or liquid phase to solid phase, in specific temperature ranges. During these phase changes, the PCMs absorb or release large amounts of latent heat. Common phase change materials include paraffinic hydrocarbons (CₙH₂ₙ₊₂). PCMs are characterized by absorbing and releasing large amounts of latent heat during phase changes thereby keeping the system temperature constant. The heat reservation properties of PCMs result in PCMs being commonly used in the manufacture of heat reservation fabrics.

Conventionally, two methods are used to incorporate PCMs into fabrics. One method includes wrapping PCMs in microcapsules which, in turn, is applied to the surface of the textile fiber or woven. The other method includes wrapping PCMs in microcapsules which, in turn, is added into the spinning fluid of acrylic resin, and forming acrylic fibers by wet spinning. Both of the methods mentioned above involve encapsulating PCMs into microcapsules. In the first method, the microcapsules have PCMs wrapped therein and adhered to the surface of textile fiber or woven by a finishing step. However, the microcapsules added to the fabric using this method may easily peel off, limiting the applications of the first method. The second method involves direct application on spinning and using solvent which resulted in the problems of solvent recycling and environmental protection.

However, in common artificial fibers, e.g. acrylic fibers, nylon fibers, polyester fibers, polypropylene fibers, and other similar fibers, only acrylic fibers can be produced by wet spinning while most of the other artificial fibers are produced by melt spinning. During a melt spinning process, temperatures involved are typically in the range of from about 200° C. to about 380° C., and pressures may be as high as 3000 pounds per square inch. Such processing conditions may induce degradation of certain phase change materials such as carboxylic ester disclosed in U.S. Pat. Pub. No. 2004/0026659, since thermal gravity analysis shows that the maximum thermo-gravimetric-loss temperature of the carboxylic ester is at about 230° C. Some research has been conducted on the problems mentioned above.

For example, U.S. Pat. No. 6,689,466, entitled “Stable Phase Change Materials for Use in Temperature Regulating Synthetic Fibers, Fabrics And Textiles”, describes a stabilized phase change composition comprising a phase change material, an antioxidant and a heat-stabilizing agent. The antioxidant and the heat-stabilizing agent provide antioxidative and thermal stability to the phase change material such that the stabilized phase change composition may be incorporated in meltable particles for conducting a variety of melting processes of polymer.

U.S. Pat. No. 6,793,856, entitled “Melt Spinnable Concentrate Pellets Having Enhanced Reversible Thermal Properties”, discloses that PCMs can be microencapsulated in microcapsules or directly concentrated into melt spinnable pellets. The major ingredient of the melt spinnable pellet is a thermoplastic polymer.

Another patent relevant to the two patents mentioned above is TW Pat. No. 587110, entitled “Multi-Component Fibers Having Enhanced Reversible Thermal Properties and Methods of Manufacturing Thereof,” which describes multi-component fibers formed by a melt spinning process. The multi-component fiber is a composite fiber comprised of at least two kinds of fibers, e.g. island-in-sea type fiber or core-sheath type fiber.

### SUMMARY OF THE INVENTION

It is an aspect of the present invention to provide a high temperature endurable phase change polymer suitable for use in high-temperature processing.

It is another aspect of the present invention to provide a phase change polymer with a low melting point and a high boiling point that is suitable for use in regulating human body temperature.

To achieve the above listed and other aspects, the present invention provides a high temperature endurable phase change polymer including a polyether fatty acid ester undergoing physical phase changes from solid phase to liquid phase or liquid phase to solid phase in a temperature range of about 0° C. to about 80° C. with a maximum thermo-gravimetric-loss temperature of at least about 350° C.

In one embodiment of the present invention, the polyether main chain of the polyether fatty acid ester is polyethylene glycol or polytetramethylene glycol. The polyethylene glycol preferably has a molecular weight between 200 g/mol and 20,000 g/mol. The polytetramethylene glycol preferably has a molecular weight between 650 g/mol to about 3,000 g/mol. Preferably the polyether fatty acid ester has two C4-C28 terminal fatty acyl groups.

To achieve the above listed and other objects, the present invention further provides a method of making the polyether fatty acid ester mentioned above. The method involves esterifying a polyether diol with a fatty acid or a fatty acyl halide.

Thermal gravity analysis shows that the aforementioned polyether fatty acid ester has a maximum thermo-gravimetric-loss temperature of about 370° C. to about 400° C., and therefore can be used in a melt spinning process. Furthermore, the aforementioned polyether fatty acid ester has a melting point between 16.3° C. and 57.6° C. which is close to human body temperature, and therefore suitable for regulating human body temperature. In addition, starting materials of the aforementioned polyether fatty acid ester are relatively easy to acquire, thereby significantly reducing the manufacturing cost.

### DETAILED DESCRIPTION OF THE PREFERRED EMBODIMENT

The present invention is directed to a high temperature endurable phase change polymer having a low melting point and a high boiling point. Since body surface temperature typically varies between 30° C. and 35° C., a phase change polymer with a melting point close to body temperature is suitable for use in making clothes capable of regulating human body temperature. However, temperatures involved in a melt spinning process for producing artificial fibers are typically in the range of from about 200° C. to about 380° C. Accordingly, there exists a need for a phase change polymer with a high boiling point such that the artificial fibers can be produced by the melt spinning process.

The present invention provides a polyether fatty acid ester undergoing physical phase changes from solid phase to liquid phase or liquid phase to solid phase in a temperature range of about 0° C. to about 80° C. and having a maximum thermo-gravimetric-loss temperature of at least about 350° C. The polyether main chain of the polyether fatty acid ester is preferably polyethylene glycol or polytetramethylene glycol. The polyethylene glycol preferably has a molecular weight between 200 g/mol and 20,000 g/mol. The polytetramethylene glycol preferably has a molecular weight between 650 g/mol and 3,000 g/mol. Preferably, the polyether fatty acid ester has two C4-C28 terminal fatty acyl groups such as stearoyl group (C₁₈H₃₅O₂—), palmitoyl group (C₁₆H₃₁O₂—), or lauroyl group (C₁₂H₂₃O₂—).

The polyether fatty acid ester may be produced by esterifying a polyether diol with a fatty acid or a fatty acyl halide such as fatty acyl chlorides, fatty acyl bromides, and fatty acyl iodides. The polyether diol is preferably polyethylene glycol or polytetramethylene glycol. The polyethylene glycol preferably has a molecular weight between 200 g/mol and 20,000 g/mol. The polytetramethylene glycol preferably has a molecular weight between 650 g/mol between 3,000 g/mol.

The fatty acid mentioned above may be a saturated fatty acid or its derivative. Alternatively, the fatty acid mentioned above may be an unsaturated fatty acid or its derivative containing a carbon-carbon double bond. The fatty acid preferably contains 4 to 28 carbons, e.g., stearoyl acid, palmitoyl acid, and lauroyl acid. The fatty acyl halide mentioned above may be a saturated fatty acyl halide or its derivative. Alternatively, the fatty acyl halide mentioned above may be an unsaturated fatty acyl halide or its derivative containing a carbon-carbon double bond. The fatty acyl halide preferably contains 4 to 28 carbons, e.g., stearoyl chloride, palmitoyl chloride, and lauroyl chloride.

### EXAMPLE 1

Polyethylene glycol 600 (60 g) was mixed with stearoyl acid (57 g), sulfuric acid (1 mL), and toluene (200 mL). The mixture was refluxed to reduce the moisture in the reaction system thereby helping esterification. The product of the reaction is purified to obtain polyethylene glycol 600 distearoyl ester. The melting point of the polyethylene glycol 600 distearoyl ester is determined using differential scanning calorimetry (DSC) was 38.4° C. Based on the thermo-gravimetric curve determined with thermal gravity analyzer (TGA), the maximum thermo-gravimetric-loss temperature of the polyethylene glycol 600 distearoyl ester is about 389° C.

### EXAMPLE 2

Polyethylene glycol 1500 (150 g) was mixed with stearoyl acid (57 g), and p-toluene sulfonic acid (1 g). The mixture was heated under vacuum to reduce the moisture in the reaction system. The product of the reaction is purified to obtain polyethylene glycol 1500 distearoyl ester. The melting point of the polyethylene glycol 1500 distearoyl ester is determined using differential scanning calorimetry (DSC) was 35.0° C. Based on the thermo-gravimetric curve determined with thermal gravity analyzer (TGA), the maximum thermo-gravimetric-loss temperature of the polyethylene glycol 1500 distearoyl ester is about 392° C.

### EXAMPLE 3

Polytetramethylene glycol 2000 (200 g) was mixed with stearoyl chloride (60.6 g), and N,N-dimethylformamide (200mL). The mixture was heated and the gaseous hydrochloride formed in the reaction was captured and neutralized. The reaction product is purified to obtain polytetramethylene glycol 2000 distearoyl ester. The melting point of the polytetramethylene glycol 2000 distearoyl ester is determined using differential scanning calorimetry (DSC) was 28.9° C. Based on the thermo-gravimetric curve determined with thermal gravity analyzer (TGA), the maximum thermo-gravimetric-loss temperature of the polytetramethylene glycol 2000 distearoyl ester is about 398° C.

The physical properties of the prepared phase change polymers is listed below. Table 1 shows the melting points and the maximum thermo-gravimetric-loss temperatures of polyethylene glycol fatty acid esters. Table 2 shows the melting points and the maximum thermo-gravimetric-loss temperatures of polytetramethylene glycol fatty acid esters. Table 1 shows that polyether fatty acid ester synthesized by polyethylene glycol has a melting point of about 32-58° C. and a maximum thermo-gravimetric-loss temperature of about 387-395° C., and therefore is very suitable for use in producing artificial fibers by a melt spinning process. Table 2 also shows that polyether fatty acid ester synthesized by polytetramethylene glycol has a lower melting point of about 16-34° C. and a maximum thermo-gravimetric-loss temperature of about 376-396° C.

TABLE 1
The melting points and the maximum thermo-gravimetric-loss
temperatures of polyethylene glycol fatty acid esters.

| | | Maximum |
|---|---|---|
| Polyethylene glycol fatty acid | Melting point | thermo-gravimetric-loss |
| ester | (° C.) | temperature (° C.) |
| Polyethylene glycol 6000 | 57.6 | 394 |
| distearoyl ester | | |
| Polyethylene glycol 6000 | 57.6 | 389 |
| dilauroyl ester | | |
| Polyethylene glycol 4000 | 55.0 | 390 |
| distearoyl ester | | |
| Polyethylene glycol 4000 | 54.4 | — |
| dilauroyl ester | | |
| Polyethylene glycol 2500 | 49.5 | 389 |
| distearoyl ester | | |
| Polyethylene glycol 1500 | 44.8 | 393 |
| distearoyl ester | | |
| Polyethylene glycol 1000 | 38.3 | — |
| distearoyl ester | | |
| Polyethylene glycol 600 | 38.5 | 389 |
| distearoyl ester | | |
| Polyethylene glycol 400 | 45.9 | 387 |
| distearoyl ester | | |
| Polyethylene glycol 200 | 45.0 | 388 |
| distearoyl ester | | |

TABLE 2
The melting points and the maximum thermo-gravimetric-loss
temperatures of polytetramethylene glycol fatty acid esters.

| | | Maximum |
|---|---|---|
| Polytetramethylene fatty acid | Melting | thermo-gravimetric-loss |
| ester | point (° C.) | temperature (° C.) |
| Polytetramethylene glycol | 29.0 | — |
| 3000 distearoyl ester | | |
| Polytetramethylene glycol | 28.9 | 399 |
| 2000 distearoyl ester | | |
| Polytetramethylene glycol | 26.4 | 391 |
| 2000 dilauroyl ester | | |
| Polytetramethylene glycol | 29.6 | — |
| 1800 distearoyl ester | | |
| Polytetramethylene glycol | 24.3 | — |
| 1800 dilauroyl ester | | |
| Polytetramethylene glycol | 31.0 | — |
| 1000 distearoyl ester | | |
| Polytetramethylene glycol 850 | 33.4 | 376 |
| distearoyl ester | | |
| Polytetramethylene glycol 850 | 29.3 | — |
| diplmitoyl ester | | |
| Polytetramethylene glycol 850 | 16.3 | — |
| dilauroyl ester | | |

According to the embodiments mentioned above, the present invention utilizes easily accessible industrial raw materials to synthesize a novel high temperature endurable phase change polymer with a low melting point. Therefore, the phase change polymers of the present invention are very suitable for being combined with other artificial-fiber materials to form fabrics capable of regulating human body temperature by a melt spinning process. The phase change polymers of the present invention may be incorporated into melt spinnable pellets which, in turn, can be used in a melt spinning process to form core-sheath type fibers or island-in-sea type fibers. Alternatively, the phase change polymers of the present invention may be added into a spinning fluid which, in turn, can be used to form artificial fibers by wet spinning. The phase change polymers of the present invention may also be melted and then permeated into a fiber structure via spraying thereby giving the fiber structure the functions of temperature regulation and heat reservation. Accordingly, the phase change polymers of the present invention have various applications.

As is understood by a person skilled in the art, the foregoing preferred embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A high temperature endurable phase change polymer comprising a polyether fatty acid ester undergoing physical phase changes from solid phase to liquid phase or liquid phase to solid phase in an approximate temperature range of about 0-80° C. and having a maximum thermo-gravimetric-loss temperature of at least about 350° C.

2. The polymer according to claim 1, wherein a polyether main chain of the polyether fatty acid ester is polyethylene glycol or polytetramethylene glycol.

3. The polymer according to claim 2, wherein the polyethylene glycol has a molecular weight from about 200 g/mol to about 20,000 g/mol.

4. The polymer according to claim 2, wherein the polytetramethylene glycol has a molecular weight from about 650 g/mol to about 3,000 g/mol.

5. The polymer according to claim 1, wherein two terminals of the polyether fatty acid ester are two fatty acyl groups having 4-28 carbons.

6. The polymer according to claim 1, wherein the acyl groups are selected from the group consisting of stearoyl group, palmitoyl group, and lauroyl group.

7. A method of making a high temperature endurable phase change polymer comprising esterifying a polyether diol with a fatty acid or a fatty acyl halide selected from the group consisting of fatty acyl chlorides, fatty acyl bromides, and fatty acyl iodides.

8. The method according to claim 7, wherein the polyether diol is polyethylene glycol or polytetramethylene glycol.

9. The method according to claim 8, wherein the polyethylene glycol has a molecular weight from about 200 g/mol to about 20,000 g/mol.

10. The method according to claim 8, wherein the polytetramethylene glycol has a molecular weight from about 650 g/mol to about 3,000 g/mol.

11. The method according to claim 7, wherein the fatty acid is a saturated fatty acid or its derivative containing 4 to 28 carbons.

12. The method according to claim 7, wherein the fatty acid is an unsaturated fatty acid or its derivative containing a carbon-carbon double bond and 4 to 28 carbons.

13. The method according to claim 7, wherein the fatty acid is stearoyl acid, palmitoyl acid, or lauroyl acid.

14. The method according to claim 7, wherein the fatty acyl halide is a saturated fatty acyl halide or its derivative containing 4 to 28 carbons.

15. The method according to claim 7, wherein the fatty acyl halide is an unsaturated fatty acyl halide or its derivative containing a carbon-carbon double bond and 4 to 28 carbons.

16. The method according to claim 7, wherein the fatty acyl halide is stearoyl halide, palmitoyl halide, or lauroyl halide.
